(19) United States
(12) Patent Application Publication
(10) Pub. No.: US 2013/0268109 A1
(43) Pub. Date: Oct. 10, 2013

(54) SYSTEM AND METHOD FOR MEASURING CUTTING TOOL

(71) Applicants: HONG FU JIN PRECISION INDUSTRY (SHENZHEN) CO., LTD., Shenzhen (CN); HON HAI PRECISION INDUSTRY CO., LTD., New Taipei (TW)

(72) Inventors: CHIH-KUANG CHANG, New Taipei (TW); XIN-YUAN WU, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/776,748

(22) Filed: Feb. 26, 2013

(30) Foreign Application Priority Data
Apr. 9, 2012 (CN) 201210100800.1

(51) Int. Cl. G05B 19/41

(52) U.S. Cl. CPC G05B 19/41
USPC 700/187

(57) ABSTRACT

A computing device is electronically connected with an image measuring machine. A cutting tool is fixed on a rotatable holder of the image measurement machine. The rotatable holder rotates the cutting tool, and an image capturing device captures one or more images of the cutting tool. The image measurement machines transmits image data in relation to the cutting tool, including X, Y coordinate values of pixels in each image measured by X, Y raster rulers, and a Z coordinate value of each image measured by a Z raster ruler, to the computing device. The computing device determines three-dimensional (3D) contour points of the cutting tool by processing the image data, aligns the set of 3D contour points with a reference contour image of the cutting tool, and determines whether a design of the cutting tool is qualified according to the set of 3D contour points and the reference contour image.

### BACKGROUND

1. Technical Field

Embodiments of the present disclosure relate to three-dimensional (3D) measurement technology, and more particularly to a system and a method for measuring a cutting tool.

2. Description of Related Art

Cutting tools are used to remove materials from workpieces for producing products. Determining whether a cutting tool is qualified or not is often achieved by measuring the cutting tool using rulers or measuring the precision to which the workpieces were cut. The aforementioned measurement methods often involve directing human intervention, which may result in measurement errors. Therefore, an improved measurement system and method is desired.

### BRIEF DESCRIPTION OF THE DRAWINGS

FIG. 1 is a schematic diagram of one embodiment of a measurement system.

FIG. 2 is a block diagram of one embodiment of function modules of a computing device shown in FIG. 1.

FIG. 3 is a flowchart of one embodiment of a method for measuring a cutting tool.

FIG. 4 and FIG. 5 illustrate measured contour points of a cutting tool and a reference contour image of the cutting tool.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language. One or more software instructions in the modules may be embedded in firmware, such as in an erasable programmable read only memory (EPROM). The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

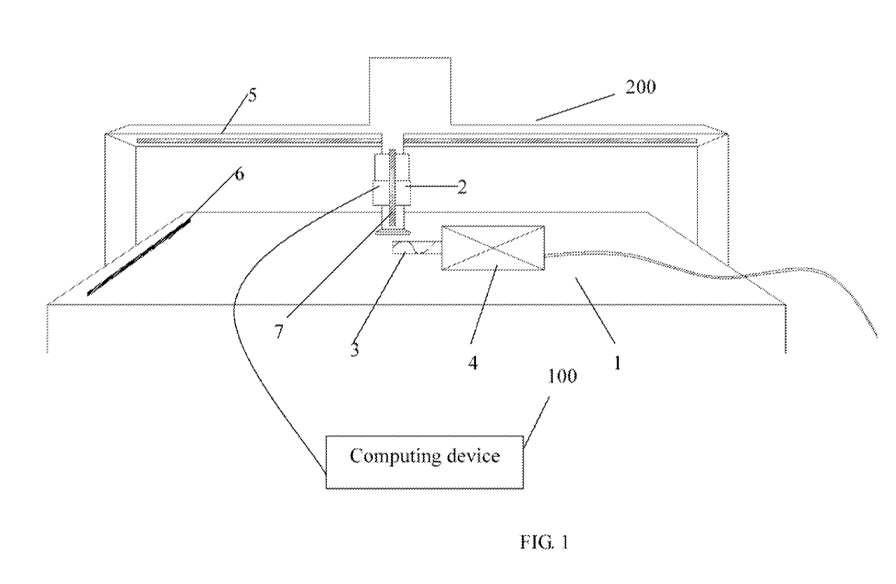

FIG. 1 is a block diagram of one embodiment of a schematic diagram of a system for measuring a cutting tool 3. The system includes a computing device 100 and an image measurement machine 200, which is electronically connected to the computing device 100. The image measurement machine 200 includes a measurement table 1, and an image capturing device 2. An X raster ruler 5, a Y raster ruler 6, and a Z raster ruler 7 that are respectively installed on X, Y, and Z axes of the image measurement machine 200. A rotatable holder 4 is located on the measurement table 1, and the cutting tool 3 is fixed on the rotatable holder 4. The cutting tool 3 may include one or more cutting edges. In one embodiment, as shown in FIG. 1, a major axis of the cutting tool 3 is parallel to the measurement table 1.

The rotatable holder 4 rotates the cutting tool 3 in preset steps, such as 0.2 millimeters/per step. Every time the rotatable holder 4 stops rotating, the image capturing device 2 captures one or more images of each cutting edge of the cutting tool 3. The X, Y raster rulers measure X, Y coordinate values of pixels in each image, and the Z raster rulers measures a Z coordinate value of each image. The image measurement machine 200 transmits the images and the measurement data in relation to the images, such as the X, Y, and Z coordinate values measured by the X, Y, and Z rulers 5-7, to the computing device 100.

The computing device 100 controls rotation of the rotatable holder 4, determines three-dimensional (3D) contour points of the cutting tool 3 by processing the images and the measurement data in relation to the images, determines differences between the 3D contour points and a reference contour image of the cutting tool 3, and determines whether a design of the cutting tool 3 is qualified according to the differences.

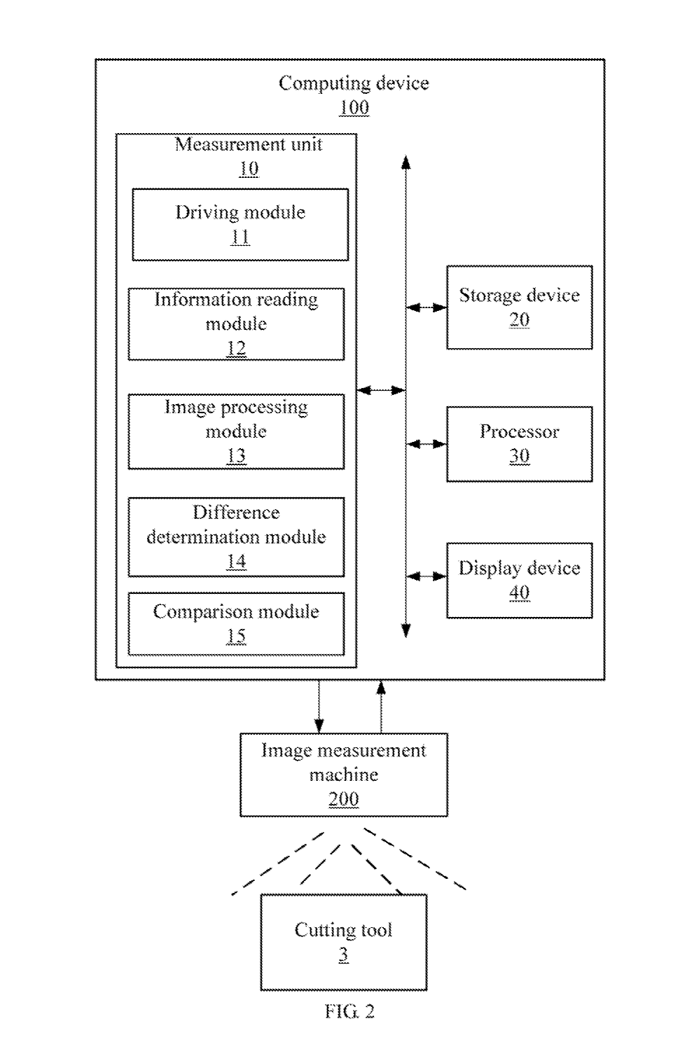

FIG. 2 is a block diagram of one embodiment of function modules of the computing device 100 shown in FIG. 1. The computing device 100 includes a measurement unit 10, a storage device 20, a processor 30, and a display device 40. The storage device 20 stores the images and the measurement data in relation to the images, such as the X, Y, and Z coordinate values measured by the X, Y, and Z rulers 5-7, transmitted from the image measurement machine 200. The storage device 20 may be a dedicated storage medium, such as an EPROM, a hard disk driver (HDD), or a flash memory. The display device 40 displays the images, the 3D contour points and the reference contour image of the cutting tool 3 to users.

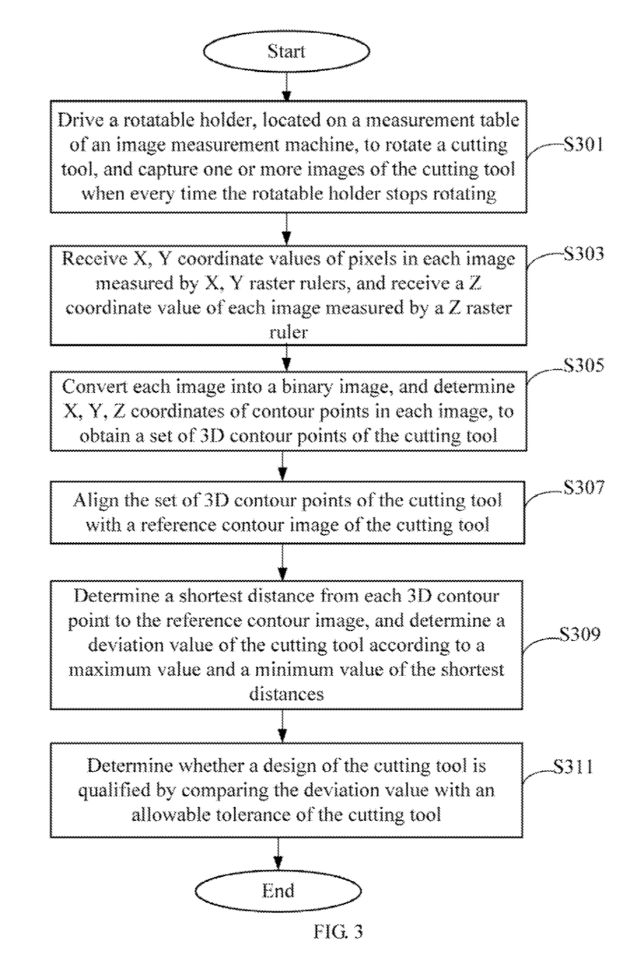

The measurement unit 10 includes a driving module 11, an information reading module 12, an image processing module 13, a difference determination module 14, and a comparison module 15. The modules 11-15 include computerized code in the form of one or more programs (computer-readable program code) that are stored in the storage device 20. The computerized code includes instructions that are executed by the processor 30, to provide the functions of the computing device 100 as described above. A description of functions of the modules 11-14 is given below and with reference to FIG. 3.

FIG. 3 is a flowchart of one embodiment of a method for measuring the cutting tool 3. Depending on the embodiment, additional steps may be added, others removed, and the ordering of the steps may be changed.

In step S301, the driving module 11 sends a control command to the image measurement machine 200, and the image measurement machine 200 drives the rotatable holder 4 to rotate the cutting tool 3 according to the control command In one embodiment, the rotatable holder 4 rotates the cutting tool 3 in preset steps, such as 0.2 millimeters/per step. Every time the rotatable holder 4 stops rotating, the image capturing device 2 captures one or more images of each cutting edge of the cutting tool 3. The X, Y raster rulers measure X, Y coordinate values of pixels in each image, and the Z raster ruler measures a Z coordinate value of each image. The image measurement machine 200 transmits the image data, such as the images and the X, Y, Z coordinate values in relation to each image measured by the X, Y, and Z raster rulers 5-7, to the computing device 100.

In step S303, the information reading module 12 receives and stores the image data in the storage device 20.

In step S305, the image processing module 13 determines a set of 3D contour points of the cutting tool 3 according to the image data. For example, the image processing module 13 reads one image M1, determines contour points in the image M1, where the contour points in the image M1 are 2D points with X, Y coordinate values. Further, the image processing module 13 reads the Z coordinate value of the image M1 measured by the Z raster ruler 7, and takes the Z coordinate value of the image M1 as the Z coordinate value of each contour point in the image M1, so as to obtain a portion of 3D contour points of the cutting tool 3. In such a way, all images are processed until all of the 3D contour points (hereinafter, all of the 3D contour points are referred to “a set of 3D contour points”) of the cutting tool 3 are obtained. In addition, the image processing module 13 may further deletes duplicate 3D contour points from the set of 3D contour points.

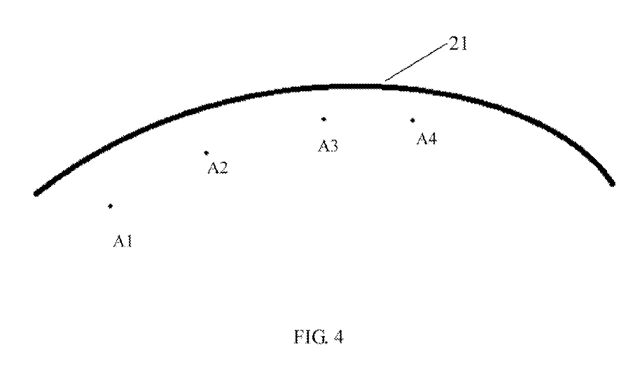

In step S307, the image processing module 13 reads a reference contour image of the cutting tool 3 from the storage device 20, and aligns the set of 3D contour points with the reference contour image. In one embodiment, the alignment operation is performed according to an algorithm, such as the least square method with the following equation:

$$f ( X ) = Min \sqrt{\frac{{\sum }_{n = 1}^{n} {( \sqrt{{( X 2 - X 1 )}^{2} + {( Y 2 - Y 1 )}^{2} + {( Z 2 - Z 1 )}^{2}} )}^{2}}{n}}$$

where (X1, Y1, Z1) represent contour points in the reference contour image of the cutting tool 3, and (X2, Y2, Z2) represent contour points in the set of 3D contour points. When f(X) has the minimum value, it represents the set of 3D contour points in alignment with the reference contour image. For example, as shown in FIG. 4, discrete points A1-A4 represents certain points of the set of 3D contour points, and a curve 21 represents the reference contour image.

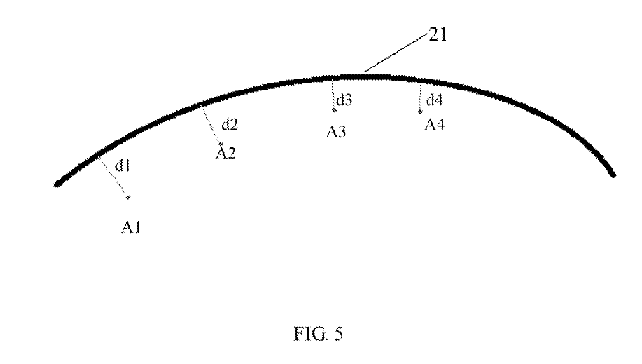

In step S309, the difference determination module 14 determines a shortest distance from each 3D contour point to the reference contour image, and determines a deviation value of the cutting tool 3 according to a maximum value and a minimum value of the shortest distances. For example, as shown in FIG. 5, a shortest distance between the point A1 and the curve 21 equals “d1,” a shortest distance between the point A2 and the curve 21 equals “d2,” a shortest distance between the point A3 and the curve 21 equals “d3,” and a shortest distance between the point A4 and the curve 21 equals “d4.” In one embodiment, the deviation value of the cutting tool 3 is calculated as follows: D1=|Dmax|+|Dmin|, where D1 represents the deviation value of the cutting tool 3, |Dmax| represents an abstract value of the maximum value of the shortest distances, and |Dmin| represents an abstract value of the minimum value of the shortest distances.

In step S311, the comparison module 15 compares the deviation value of the cutting tool 3 with a allowable tolerance of the cutting tool 3, and determines whether a design of the cutting tool 3 is qualified according to the comparison result. For example, if the deviation value is less than or equal to the allowable tolerance, the design of the cutting tool 3 is qualified. Otherwise, if the deviation value is more than the allowable tolerance, the design of the cutting tool 3 is not qualified.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a computing device for measuring a cutting tool, the computing device being electronically connected with an image measuring machine, the cutting tool being fixed on a rotatable holder located on a measurement table of the image measurement machine, the method comprising steps of:
(a) controlling the image measurement machine to drive the rotatable holder to rotate the cutting tool by sending a control command to the image measurement machine by the computing device;
(b) receiving image data in relation to the cutting tool sent from the image measurement machine, wherein the image data comprises one or more images of the cutting tool captured by an image capturing device of the image measurement machine, X, Y coordinate values of pixels in each image measured by X, Y raster rulers of the image measurement machine, and a Z coordinate value of each image measured by a Z raster ruler;
(c) determining a set of three-dimensional (3D) contour points of the cutting tool by processing the image data;
(d) aligning the set of 3D contour points with a reference contour image of the cutting tool;
(e) determining a shortest distance from each 3D contour point to the reference contour image, and determining a deviation value of the cutting tool according to a maximum value and a minimum value of the shortest distances; and
(f) determining whether a design of the cutting tool is qualified by comparing the deviation value with an allowable tolerance of the cutting tool.

2. The method of claim 1, wherein the rotatable holder rotates the cutting tool in preset steps.

3. The method of claim 1, wherein the image capturing device captures one or more images of the cutting tool when the rotatable holder stops rotating.

4. The method of claim 1, wherein step (c) comprises:
(c1) reading an image, and determining contour points in the image with X, Y coordinate values;
(c2) reading a Z coordinate value of the image, and taking the Z coordinate value of the image as Z coordinate value of each contour point in the image, so as to obtain a portion of 3D contour points of the cutting tool with X, Y, Z coordinate values; and
(c3) applying steps (c1)-(c2) to process other images until all of 3D contour point of the cutting tool are obtained.

5. The method of claim 4, wherein step (c) further comprises: deleting duplicate 3D contour points from all of the 3D contour points.

6. The method of claim 1, wherein step (f) comprises:
determining the design of the cutting tool is qualified if the deviation value is less than or equal to the allowable tolerance of the cutting tool; and
determining the design of the cutting tool is not qualified if the deviation value is more than the allowable tolerance of the cutting tool.

7. The method of claim 1, wherein the reference contour image and the allowable tolerance of the cutting tool are stored in a storage device of the computing device.

8. A system for measuring a cutting tool, the cutting tool being fixed on a rotatable holder located on a measurement table of an image measurement machine, the system comprising:
at least one processor;
a storage device having computer code stored thereon that, when executed by the at least one processor, causes the at least one processor to perform operations of:
(a) controlling the image measurement machine to drive the rotatable holder to rotate the cutting tool by sending a control command to the image measurement machine;
(b) receiving image data in relation to the cutting tool sent from the image measurement machine, wherein the image data comprises one or more images of the cutting tool captured by an image capturing device of the image measurement machine, X, Y coordinate values of pixels in each image measured by X, Y raster rulers of the image measurement machine, and a Z coordinate value of each image measured by a Z raster ruler;
(c) determining a set of three-dimensional (3D) contour points of the cutting tool by processing the image data;
(d) aligning the set of 3D contour points with a reference contour image of the cutting tool;
(e) determining a shortest distance from each 3D contour point to the reference contour image, and determining a deviation value of the cutting tool according to a maximum value and a minimum value of the shortest distances; and
(f) determining whether a design of the cutting tool is qualified by comparing the deviation value with an allowable tolerance of the cutting tool.

9. The system of claim 8, wherein the rotatable holder rotates the cutting tool in preset steps.

10. The system of claim 8, wherein the image capturing device captures one or more images of the cutting tool when the rotatable holder stops rotating.

11. The system of claim 8, wherein operation (c) comprises:
(c1) reading an image, and determining contour points in the image with X, Y coordinate values;
(c2) reading a Z coordinate value of the image, and taking the Z coordinate value of the image as Z coordinate value of each contour point in the image, so as to obtain a portion of 3D contour points of the cutting tool with X, Y, Z coordinate values; and
(c3) applying steps (c1)-(c2) to process other images until all of 3D contour point of the cutting tool are obtained.

12. The system of claim 11, wherein operation (c) further comprises: deleting duplicate 3D contour points from all of the 3D contour points.

13. The system of claim 11 wherein operation (f) comprises:
determining the design of the cutting tool is qualified if the deviation value is less than or equal to the allowable tolerance of the cutting tool; and
determining the design of the cutting tool is not qualified if the deviation value is more than the allowable tolerance of the cutting tool.

14. A non-transitory computer-readable medium having stored thereon instructions that, when executed by a processor of a computing device, causing the processor to perform a method for measuring a cutting tool, the computing device being electronically connected with an image measuring machine, the cutting tool being fixed on a rotatable holder located on a measurement table of the image measurement machine, the method comprising steps of:
(a) controlling the image measurement machine to drive the rotatable holder to rotate the cutting tool by sending a control command to the image measurement machine by the computing device;
(b) receiving image data in relation to the cutting tool sent from the image measurement machine, wherein the image data comprises one or more images of the cutting tool captured by an image capturing device of the image measurement machine, X, Y coordinate values of pixels in each image measured by X, Y raster rulers of the image measurement machine, and a Z coordinate value of each image measured by a Z raster ruler;
(c) determining a set of three-dimensional (3D) contour points of the cutting tool by processing the image data;
(d) aligning the set of 3D contour points with a reference contour image of the cutting tool;
(e) determining a shortest distance from each 3D contour point to the reference contour image, and determining a deviation value of the cutting tool according to a maximum value and a minimum value of the shortest distances; and
(f) determining whether a design of the cutting tool is qualified by comparing the deviation value with an allowable tolerance of the cutting tool.

15. The medium of claim 14, wherein the rotatable holder rotates the cutting tool in preset steps.

16. The medium of claim 14, wherein the image capturing device captures one or more images of the cutting tool when the rotatable holder stops rotating.

17. The medium of claim 14, wherein step (c) comprises:
(c1) reading an image, and determining contour points in the image with X, Y coordinate values;
(c2) reading a Z coordinate value of the image, and taking the Z coordinate value of the image as Z coordinate value of each contour point in the image, so as to obtain a portion of 3D contour points of the cutting tool with X, Y, Z coordinate values; and
(c3) applying steps (c1)-(c2) to process other images until all of 3D contour point of the cutting tool are obtained.

18. The medium of claim 17, wherein step (c) further comprises: deleting duplicate 3D contour points from all of the 3D contour points.

19. The medium of claim 14, wherein step (f) comprises:
determining the design of the cutting tool is qualified if the deviation value is less than or equal to the allowable tolerance of the cutting tool; and
determining the design of the cutting tool is not qualified if the deviation value is more than the allowable tolerance of the cutting tool.

20. The medium of claim 14, wherein the reference contour image and the allowable tolerance of the cutting tool are stored in a storage device of the computing device.
